(19) United States
(12) Patent Application Publication
(10) Pub. No.: US 2003/0211218 A1
(43) Pub. Date: Nov. 13, 2003

(54) Yogurt production process and products

(76) Inventors: Antoine J. Cote, Salem, MA (US); Timothy T. Johnson, St. Anthony Village, MN (US)

Correspondence Address: GENERAL MILLS, INC., P.O. BOX 1113, MINNEAPOLIS, MN, 55440, US

(21) Appl. No.: 10/147,246

(22) Filed: May 13, 2002

(51) Int. Cl. A23C 17/00

(52) U.S. Cl. 426/583

(57) ABSTRACT

Methods of preparation for cultured milk based products and products prepared thereby are provided wherein a yogurt base is produced having a viscosity of at least 75,000 cps. at time of manufacture and a total solids content of 27% to 31% by weight. The process involves rapid cooling to arrest fermentation under reduced backpressure by dispensing into a zone at atmospheric pressure followed by a shear step to modify viscosity to provide a high solids, high viscosity yogurt product. The high viscosity yogurt is particularly suitable for use as a component in parfait style yogurt products with at least one intermediate fruit layer. The high viscosity yogurt more effectively supports a fruit layer and facilitates fabrication of such parfait yogurt products. The yogurt base can further be characterized as increasing in viscosity by up to 25% from time of manufacture to time of consumption.

### BACKGROUND OF THE INVENTION

The present invention relates to food products and their methods of preparation. More particularly, the present invention relates to improved methods of preparation for cultured milk based products and products prepared thereby. More particularly, the improvement provides methods of preparing high viscosity stirred style yogurt products.

### BRIEF SUMMARY OF THE INVENTION

Yogurt is a nutritious popular dairy product. At retail, yogurt is now available in a wide assortment of varieties of texture, fat content, sweetener type and level, and flavor among other attributes. Other than aseptically packaged yogurt, yogurt is traditionally distributed and consumed with a live culture that requires refrigerated distribution (2° C. to 10° C.).

From a yogurt manufacturing process standpoint, all yogurts fall into one of two styles; namely, 1) set yogurts, and 2) stirred style. The present invention finds particular suitability for use in connection with the provision of stirred style yogurts. Within these broad two classifications, numerous yogurt varieties exist.

In the set style, the manufacturer fills cups or containers with an inoculated but unfermented milk base and quiescently holds the filled cups at warm temperatures (≈40° C. to 50° C.) to allow the yogurt to ferment therein. After the desired fermenting or maturing time, the product is cooled which arrests the culturing activity and also allows the body to set to form the gel-type texture. Set style yogurts have a relatively low initial viscosity (i.e., upon filling of its food package container) and a higher temperature (“temperature of filling”) compared to the viscosity of stirred style yogurt products. As the product ferments and then is cooled, its viscosity increases to its final viscosity value. A set style yogurt is characterized by a more firm, gel-like consistency and a higher final viscosity than many stirred style yogurts. In addition to the natural thickening effect of the yogurt culture, a wide variety of thickeners and stabilizers are taught as useful to supplement the yogurt's gel characteristics.

Of course, within this set style, there is a continuum of body firmness. Most set custard style products have quite firm gels although some others are much softer. One variety of a set style yogurt is a “custard” style yogurt. The softer gel products may even be perceived by the consumer as being thinner than even certain stirred style products.

One popular style variant of custard style yogurt is fruit-on-the-bottom, also colloquially referred to as “sundae” style, in which a discrete layer of fruit preserves is on the bottom of the yogurt container and the custard yogurt fills the rest of the container. Fruit on the top style products are similarly prepared, except that the containers are typically inverted after having been allowed to set. Typically, the yogurt phase is unflavored, although occasionally sweetened, and of a white or natural color. This white color is in contrast to the separate fruit preserve layer which often contains additional coloring supplemental to that coloring provided by the ingredients of the fruit preserves. An alternative, is to flavor and/or color the white mass to complement or contrast with the fruit preparation. Other than for moisture equilibration, the yogurt layer and the fruit preserve layer usually do not intermix over time due to specific gravity difference and the binding effect of pectin in the fruit preserves.

In the second general category of yogurt products, the yogurt is of a stirred type. In producing stirred yogurt products, the manufacturer 1) ferments an inoculated milk base in bulk, e.g., in large stirred fermentation or culturing tanks, 2) cools the yogurt so formed to arrest the fermentation, and then 3) fills the individual yogurt container with thickened yogurt. Such production facilities are run in a continuous or semi-continuous manner. More specifically, after fermentation to desired acidity and thickness, the yogurt is pumped through cooling heat exchangers to arrest the fermentation. The cooling also typically results in an increase in the viscosity of the yogurt. Flavorings and sweeteners can be admixed with the cooled yogurt and the yogurt is charged to containers. Conventionally, care needs to be taken to minimize the shear imparted to the yogurt in practicing such process steps to minimize the loss of thickness or viscosity built up by the fermentation step as augmented by cooling. Thus, the stirred style yogurt typically has a higher viscosity than set style yogurts upon filling due to the lower temperature and the thickening affect of yogurt culture. Nonetheless, the stirred style yogurt typically builds or increases substantially in viscosity after filling over time until reaching its intended finish viscosity. Of course, stirred yogurts also come in various styles and product variations.

Most commonly, fruit preserves or purees are stirred into the stirred yogurt immediately prior to filling. Such stirred style yogurts comprising intermixed fruit purees are sometimes referred to most frequently as “Swiss” style or, less frequently but equivalently as “Continental” or “French” style. Occasionally, stirred Swiss style yogurts are formulated with excessive amounts of stabilizers with the result that after refrigerated storage for 48 hours, the yogurt possesses a solid-like consistency, somewhat reminiscent of custard style yogurt.

A first “parfait” style yogurt can comprise two or more layers of each comprising differently colored and/or flavored stirred style yogurt layers or portions. (See for example, U.S. Pat. No. 6,235,320 “Colored Multi-layered Yogurt and Methods of Preparation” issued May 22, 2001 to Daravingas et al. and which is incorporated herein by reference.) The yogurt layers or portions described therein are of high viscosity (15,000-30,000 cps) compared to conventional stirred yogurts (≈8,000 to 12,000 cps.) to avoid intermixing of the parfait layers during manufacture, distribution and storage.

A second “parfait” or “trifles” style yogurt product can contain a stirred style yogurt. The stirred “parfait” style yogurt product, can be manufactured just prior to consumption, in which discrete layers of fruit pieces are contained between layers of the stirred style yogurt. Typically, the yogurt phase is flavored, and of a white or natural color. This white color is in contrast to the separate fruit pieces layers which often are in a frozen state during production of the “parfait” yogurt product. The fruit pieces contained in the “parfait” are initially in a frozen state to minimize moisture equilibration and intermixing between the yogurt layer and the fruit pieces layer, thus extending product shelf-life providing a more organoleptically desirable product for the consumer. The stirred style “parfait” yogurt is generally characterized as having a viscosity of at least 40,000 cps. The yogurt thickness desirably assists in the separation of the yogurt and fruit piece layers of the “parfait” product.

As can be appreciated from the above description of the numerous styles and flavors within styles of yogurts, product proliferation and differentiation is an important characteristic of commercial yogurt manufacture. In this highly competitive food product category, there is a continuing desire to develop novel products having distinctive visual, taste, and textural variations in order to stimulate interest in yogurt sales.

The present invention finds particular suitability for use in connection with the provision of stirred style yogurts. A good description of preparing a fermented stirred yogurt is contained in commonly assigned U.S. Pat. No. 5,820,903 entitled “Calcium Fortified Yogurt and Methods of Preparation” (issued Oct. 13, 1998 to Fleury et al.) which is incorporated herein by reference.

The present invention resides in the addition of a processing step after arresting fermentation. The improvement provides increased through puts, surprisingly, the improvement additionally provides flexibility in altering the finished product viscosity, and the organoleptic properties.

### BRIEF DESCRIPTION OF THE DRAWINGS

FIG. 1 is a schematic process flow diagram illustrating the method of preparation of the present invention.

### DETAILED DESCRIPTION OF THE INVENTION

The present invention relates to an improved method of preparation for cultured milk based products, more particularly yogurt products. The preparation steps as well as product components, product use and attributes are described in detail below.

Referring now to the drawing, it can be seen that in the present methods generally designated by reference numeral 10, the first essential step is to provide a warm fermented dairy base such as a yogurt. Conventional methods and techniques can be used to practice this step.

Conveniently, this first step can include the substeps of (1) providing a milk base 17, (2) homogenizing the milk base 19, (3) pasteurizing the homogenized milk base 21, (4) bringing the pasteurized milk base to fermenting temperatures 23 such as by cooling, (5) adding a starter culture 18, and (6) fermenting to desired acidities 27.

Briefly, the process typically begins with raw milk, that may contain a combination of whole milk, skim milk, condensed milk, dry milk (dry milk solids non-fat or, equivalently, “MSNF”), grade A whey, cream and/or such other milk fraction ingredients as buttermilk, whey, lactose, lactalbumins, lactoglobulins, or whey modified by partial or complete removal of lactose and/or minerals, other dairy ingredients to increase the nonfat solids content, which are blended to provide the desired fat and solids content. While not preferred, the milk base can include a filled milk component, i.e., a milk ingredient having a portion supplied by a non-milk ingredient, e.g., oil or soybean milk.

While in the present invention, particular emphasis is directed towards fermented bovine milk products such as yogurt, the skilled artisan will appreciate that the present invention is also suitable for use in a wide variety of thickened dairy products, particularly fermented dairy products such as kefir, sour cream and the like.

Also, while bovine milk is preferred, other milks can be used in substitution for bovine milk whether in whole or in part, e.g., goat, sheep or equine milk.

The milk base 17 can further include sweeteners. The milk base can optionally further comprise a nutritive carbohydrate sweetening agent(s). Exemplary useful nutritive carbohydrate sweetening agents include, but are not limited to, sucrose, high fructose corn syrup, dextrose, various DE (Dextrose Equivalent) corn syrups, beet or cane sugar, invert sugar (in paste or syrup form), brown sugar, refiner's syrup, molasses (other than blackstrap), fructose, fructose syrup, maltose, maltose syrup, dried maltose syrup, malt extract, dried malt extract, malt syrup, dried malt syrup, honey, maple sugar, except table syrup and mixtures thereof.

Conveniently, the raw milk and sweeteners (such as fructose, corn syrup, sucrose) can be blended in a first mix tank 11 and stored in a milk silo 13. Minor ingredients such as stabilizers and thickeners such as starch, gelatin, pectin, agar carrageenan and mixtures thereof can also be added if desired. The minor ingredients are combined with the sweetened milk to form the milk base 17 conveniently in a separate mixing vessel 15.

Next, the milk base 17 is homogenized 19 in a conventional homogenizer to disperse evenly the added materials and the fat component supplied by various ingredients thereby forming an homogenized milk base. If desired, the milk base 17 can be warmed prior to homogenization from typical milk storage temperatures of about 5° C. to temperatures of about 65° to 75° C.

This homogenized milk base is then pasteurized 21, typically by heating for times and temperatures effective to accomplish pasteurization to form a pasteurized milk base. As is well known, the milk base 17 can be heated to lower temperatures for extended time, e.g., 88° C. for 30 minutes, or alternately to higher temperatures, e.g., 95° C., for shorter times, e.g., for about 38 seconds. Of course, intermediate temperatures for intermediate times can also be employed. Other pasteurization techniques can be practiced (e.g., light pulse, ultra high pressure, etc.) if effective and economical. In certain commercial practices, the sequence of the homogenization and pasteurization steps can be reversed.

The homogenized and pasteurized base is then brought to incubation temperature, usually about 40° to 46° C. When heat pasteurization is employed, this step typically is a cooling step 23.

Thereafter, the homogenized and pasteurized milk blend is inoculated with a desired culture 18. Usually, a combination of Lactobacillus bulgaricus and Streptococcus thermophilus bacteria is added to begin the fermentation process. In other variations, the yogurt culture can additionally include a Lactbacillus bifidus and/or a Lactbacillus acidophilus bacteria. The fermentation step 27, is quiescently continued until the pH of the milk blend reaches approximately 4.4 to 4.6 endpoint to form a fermented dairy or yogurt base. Depending upon temperature and amount of culture added, this may take from about three to about 14 hours. It is important that the mixture not be agitated during the fermentation process to allow proper curd formation. When the proper pH has been reached, the yogurt can be pumped through a shear valve.

The particular fermentation endpoint pH can vary modestly. Typically, the endpoint can range from about 4.2 to 4.6, preferably about 4.45 to 4.55.

The yogurt base thus prepared is characterized by a viscosity of at least 15,000 cps. preferably at least 18,000 cps. (at 40° C. to 60° C.). Yogurt viscosities can range up to 20,000 cps. at this stage. The yogurt base can further be characterized as having a total solids content of 27% to 33% by weight.

The present methods essentially comprise the step of thereafter cooling the yogurt 31 (e.g., to about 2° to 21° C.) to arrest further growth and any further drop in the pH. In a preferred variation, the cooling step is performed rapidly, e.g., by passing through a heat exchanger having an average residence time of about 10 to 100 seconds.

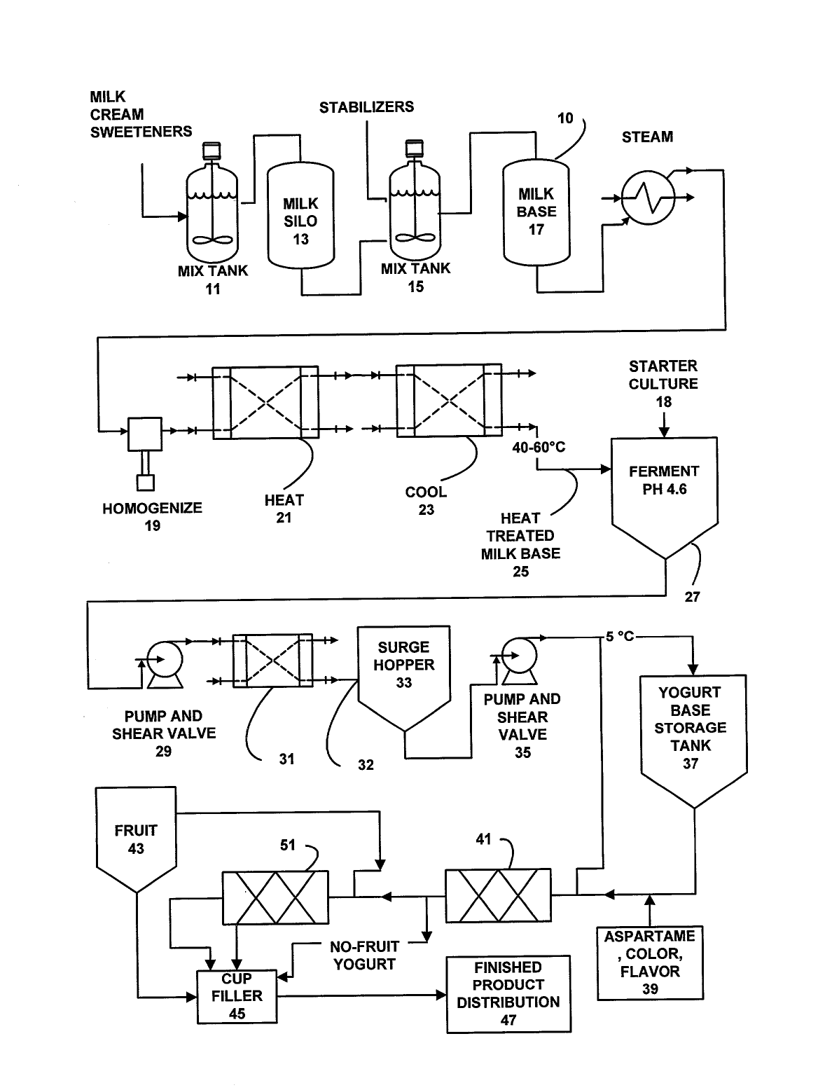

Still referring to FIG. 1, it can be seen that the present methods also essentially comprise the step thereafter of discharging 32 the cooled fermented dairy product into a zone maintained at atmospheric pressure. Conveniently, this step can be practiced by feeding or discharging the yogurt base into a surge hopper 33 having a residence time of 40 seconds or less, preferably 30 seconds or less, and thereafter the yogurt base is pumped through a valve 35, referred to as a shear valve. A bottom-fed surge hopper is preferred for the application. Although it can be appreciated that a variety of pumps are suitable for pumping the yogurt base, preferred for use herein is a Waukesha Cherry-Burell Universal Series PD Pump Model 220-U2, manufactured by Waukesha Cherry Burell having an address of 611 Sugar Creek Road, Delavan, Wis. 53115. The pump has a bi directional flow, large diameter shafts for greater strength, a rotor/shaft connection sealed from the product zone, advanced sanitation capabilities including clean-in-place, and can handle capacities of up to 310 gallons per minute (4914 l/s) with maximum pressure of up to 300 PSI (1950 KPa).

It will also be appreciated that a variety of shear valves may be employed in this application, preferred for use herein is a Tri-Clover model 771 S-10M-14D-3-316L-FFY valve manufactured by Tri-Clover having an address of P.O. Box 1413, Kenosha, Wis. 53141. The valve is preferred for this application as a result of its capacity to maintain level and pressure controls of the product.

The implementation of the new step 32 in the production process has surprisingly resulted in a two-fold through put increase for standard yogurt products having a viscosity of at least 1,500 cps. In one example, the through put at the arresting fermentation cooling stage increased from 50 gallons per minute (755 l/s) to 100 gallons per minute (1585 l/s), without an increase in line pressures. Pressure through the pump and shear valve were maintained between 100 PSI (650 KPa.) to 150 PSI (1000 KPa.), depending on the yogurt product formulation.

In another example, an ultra thick yogurt base having a viscosity of at least 40,000 cps. was cooled at a rate of 30 to 50 gallons per minute (475 l/s to 755 l/s) with a line pressure of 220 PSI (1430 KPa) using a standard yogurt production process wherein the surge hopper 33, pump and valve 35 are not contained in the system after the cooling stage 31. Surprisingly, the invention allows the same ultra thick yogurt product having a viscosity of at least 40,000 cps. to flow through the cooling stage at a rate of 60 gallons per minute (950 l/s) while maintaining a line pressure at 150 PSI (1000 KPa). The addition of the surge hopper 33, and pump and shear valve 35 after the cooling stage 31 eliminated a number of equipment issues associated with producing a high viscosity product. The high pressures associated with the typical yogurt production process caused pump failures, broken clamps, broken lines, etc. The new process eliminates or significantly reduces the equipment issues, lengthening the life of the equipment, as well as reducing the frequency of preventative maintenance check-ups required for the equipment.

The addition of the surge hopper, pump and shear valve after the cooling stage allows the fermented base to flow through the cooling plate at a lower back pressure than in the standard yogurt process wherein the fermented base is conveyed directly to the storage tank 37 via a pump and shear valve 29 contained in the system prior to the cooling stage 31. In the present invention, the efficiency of the cooling stage 31 was not impaired despite higher flow rates. While not wishing to be bound by the proposed theory, it is theorized herein that the reduced back pressure allows standard stirred style yogurt and ultra thick stirred style yogurt to flow more freely through the cooling plates in the cooling stage utilizing an increased amount of the available cooling surface area.

The cold shearing of the yogurt base surprisingly improved the textural properties of the finished product. By controlling the amount of shear, it is possible to texturize the finished product and produce higher viscosities than can be obtained from the standard yogurt process. For example, the finished yogurt product produced via the standard yogurt process can be characterized as having a viscosity not greater than 69,000 cps. Wherein, the same formula as above produced a finished yogurt product via the present invention that can be characterized as having a viscosity greater than 70,000 cps., preferably greater than 75,000 cps. at time of manufacture.

The yogurt base 37 thus prepared importantly is characterized by a viscosity of at least 55,000 cps., preferably at least 60,000 cps. The resulting yogurt base can also be characterized as having a more desirable organoleptic appeal, including having a more creamy mouthfeel and appearance.

In certain embodiments, particularly low fat and/or low calorie variations, the yogurt product herein comprises a high potency non-nutritive carbohydrate sweetening agent. Exemplary high potency sweeteners include aspartame, sucrose, potassium acelsufame, saccharin, cyclamates, thaumatin and mixtures thereof. Especially preferred for use herein is aspartame.

If aspartame is employed, an aqueous dispersion 39 thereof can be prepared and added to the yogurt base. As illustrated in FIG. 1, an in-line static mixer 41 can be used to blend the slurry into the yogurt base by static mixing to minimize shear. Minimum shear is desirable to avoid degrading the yogurt base's viscosity.

If desired, various flavors and colors 39 can be added with or in a manner similar to the aspartame dispersion. Illustrative flavors include vanilla, chocolate, amaretto cheesecake, white chocolate, Boston cream pie, caramel apple, banana cream pie, fruit flavors, and mixtures thereof.

If desired, the yogurt can additionally include a conventional fruit sauce or puree. If present, the fruit constituent can comprise about 5 to 15% of the yogurt product. The present method thus can comprise the optional additional step of adding a fruit sauce or puree 43. In the manufacture of Swiss-style yogurt, fruit flavoring is blended substantially uniformly throughout the yogurt after fermentation is complete but prior to packaging 43. A second static mixer 51 can be used to blend the fruit sauce into the yogurt with minimal shear.

In the manufacture of “sundae” style yogurt, fruit flavoring is deposited at the bottom of the consumer container, and the container is then filled with the yogurt mixture. To prepare a sundae style yogurt product employing a stirred style yogurt, the milk base is prepared with added thickeners and/or stabilizers to provide upon resting a yogurt texture that mimics a “set” style yogurt. In this variation, the fruit is added directly to the container, typically to the bottom, prior to filling with the yogurt.

The fruit flavoring sauce or puree used in the invention may be any of a variety of conventional fruit flavorings commonly used in yogurt products. Typical flavorings include strawberry, raspberry, blueberry, strawberry-banana, boysenberry, cherry-vanilla, peach, pineapple, lemon, orange and apple. Generally, fruit flavorings include fruit preserves and fruit or fruit puree, with any of a combination of sweeteners, starch, stabilizer, natural and/or artificial flavors, colorings, preservatives, water and citric acid or other suitable acid to control the pH.

If desired, the milk base can be formulated with thickeners and setting agents that will set up after cup filling that will impart a texture to the yogurt that mimics a set-style type yogurt product. In the present invention, a thickener can be used to produce a finished yogurt product having a viscosity of 75,000 cps. to 100,000 cps. at time of manufacture. The yogurt product thus produced can further be characterized as having an increase in viscosity of up to 25% from the time of manufacture to the time of consumption.

The products can additionally include a variety of other ingredients to increase their nutritional, organoleptic or other consumer appeal, e.g., fruit pieces, nuts, partially puffed cereals, etc.

The yogurt with or without fruit is then charged to a conventional container such as a coated paper or plastic cup. After filling, the filled containers are applied with a lid or other closure, assembled into cases and entered into refrigerated storage for distribution and sale. In one example, the yogurt is charged to a 32 ounce container, shipped in a case in units of six, and then used to manufacture a “parfait” fruit and yogurt layered product.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. Method of producing a fermented dairy product, comprising the steps of:
A. providing a warm fermented fluid dairy base at fermentation temperatures of 40° C. to 50° C. at a solids content of 27% to 31% by weight and a viscosity ranging from 15,000 cps. to 20,000 cps.;
B. rapidly cooling the warm fermented fluid dairy base through a heat exchanger having an inlet pressure of 150 PSI (1000 KPa), to provide a cooled fermented dairy base whereby fermentation is arrested and the viscosity is increased;
C. discharging the cooled fermented dairy base into a zone maintained at atmospheric pressure; and,
D. thereafter, pumping the cooled fermented dairy base into a shear valve whereby the viscosity is further increased to provide a finished fermented dairy product having a viscosity of 75,000 cps. to 100,000 cps. at a temperature of 5° C.

2. The method of claim 1 wherein the fermented dairy product is a yogurt having a viscosity of at least 75,000 cps. (at 5° C.).

3. The method of claim 1 wherein the fermented dairy product is a yogurt having a viscosity of 75,000 cps. to 100,000 cps. (at 5° C.) at time of manufacture.

4. The product produced by the method of claim 3 wherein the viscosity increases up to 25% from the time of manufacture to the time of consumer consumption.

5. The product produced by the method of claim 3 having a total solids content of 27% to 31% by weight.

6. The method of claim 1 wherein the fermented dairy product is a yogurt having a viscosity of 80,000 cps. to 90,000 cps. (at 5° C.) at time of manufacture.

7. The product produced by the method of claim 6 wherein the viscosity increases up to 25% from the time of manufacture to the time of consumer consumption.

8. The method of claim 1 wherein the fermented dairy product is a yogurt having a viscosity of 90,000 cps. to 100,000 cps. (at 5° C.) at time of manufacture.

9. The product produced by the method of claim 8 wherein the viscosity increases up to 25% from the time of manufacture to the time of consumer consumption.

10. The method of claim 1 wherein the zone of substep D is practiced employing a surge hopper exposed at atmospheric pressure.

11. The method of claim 1 further comprising subsequently adding a flavor.

12. The method of claim 1 further comprising subsequently adding a color.

13. The method of claim 1 further comprising subsequently adding a non-nutritive carbohydrate sweetener.

14. The method of claim 1 further comprising subsequently adding a fruit ingredient.

15. The dairy product prepared in accordance with the process of claim 1.

16. The yogurt product prepared in accordance with the process of claim 2.

17. The yogurt product prepared in accordance with the process of claim 3.

18. The yogurt product prepared in accordance with the process of claim 4.

19. The yogurt product prepared in accordance with the process of claim 5.

20. A yogurt product having a viscosity of 75,000 cps. to 100,000 cps. (at 5° C.) at time of manufacture.

21. The product of claim 20 having a total solids content of 27% to 31% by weight.

22. The product of claim 20 wherein the viscosity increases up to 25% from the time of manufacture to the time of consumer consumption.

23. The product of claim 20 having a viscosity of 80,000 cps. to 90,000 cps. (at 5° C.) at time manufacture.

24. The product of claim 20 having a viscosity of 90,000 cps. to 100,000 cps. (at 5° C.) at time of manufacture.

25. The product of claim 20 further comprising subsequently adding a flavor.

26. The product of claim 20 further comprising subsequently adding a color.

27. The product of claim 20 further comprising subsequently adding a non-nutritive carbohydrate sweetener.

28. The product of claim 20 further comprising subsequently adding a fruit ingredient.
